(19) United States
(12) Patent Application Publication
(10) Pub. No.: US 2015/0046837 A1
(43) Pub. Date: Feb. 12, 2015

(54) File Transfer Method and Terminal

(71) Applicant: Huawei Device Co., Ltd., Shenzhen (CN)

(72) Inventor: Lei Chen, Beijing (CN)

(21) Appl. No.: 14/523,753

(22) Filed: Oct. 24, 2014

Related U.S. Application Data
(63) Continuation of application No. PCT/CN2013/074637, filed on Apr. 24, 2013.

(30) Foreign Application Priority Data
Apr. 24, 2012 (CN) 201210123205.X

(51) Int. Cl. H04L 29/08; G06F 3/0488

(52) U.S. Cl. CPC H04L 67/06; G06F 3/0488
USPC 715/748

(57) ABSTRACT

Embodiments of a file transfer method and a terminal disclosed herein belong to the field of data transfer. The method includes: detecting, by a file sending terminal, a screen touching action of a user; after confirming that the screen touching action is a preset file transfer action, determining a to-be-transferred file according to the screen touching action, and determining a file receiving terminal that establishes a connection with the file sending terminal, where the preset file transfer action has a corresponding file transfer instruction; and performing, by the file sending terminal, a corresponding transfer operation according to the file transfer instruction. Therefore, a used connection manner does not need to be selected each time a file is transferred, implementing fast file transfer by using simple screen touching actions.

This application is a continuation of International Application No. PCT/CN2013/074637, filed on Apr. 24, 2013, which claims priority to Chinese Patent Application No. 201210123205.X, filed on Apr. 24, 2012, both of which are hereby incorporated by reference in their entireties.

### TECHNICAL FIELD

The embodiments described herein relate to the field of data transfer, and in particular, to a file transfer method and a terminal.

### BACKGROUND

With continuous development of electronic technologies, functions of terminals are increasingly improved. A user not only can use a terminal to work and play games, but also can save a large number of files in the terminal and install many application programs. Therefore, there are scenarios in which these files and application programs may need to be transferred.

In the prior art, when using a terminal to transfer a file, a user needs to select a to-be-transferred file at a sending end for file transfer and select a used transfer manner and a receiving end for file receiving; and when the receiving end receives the file, the user needs to select at the receiving end whether to receive the file.

During the implementation of the embodiments, it is found that the prior art has the disadvantage that during file transfer, the user needs to select the transfer manner each time when a file is transferred, and the user needs to select whether to receive each time when a file is received. As a result, the operation steps are tedious, and when a quantity of to-be-transferred files is large, the transfer efficiency is low.

### SUMMARY

To simplify operation steps of file transfer and improve the transfer efficiency, embodiments described herein provide a file transfer method and a terminal. According to one aspect, a file transfer method is provided, where the method includes detecting, by a file sending terminal, a screen touching action of a user. The method further includes after confirming that the screen touching action is a preset file transfer action, determining a to-be-transferred file according to the screen touching action. A file receiving terminal that establishes a connection with the file sending terminal is scanned, and the preset file transfer action has a corresponding file transfer instruction. The file sending terminal performs a corresponding transfer operation according to the file transfer instruction.

According to another aspect, a file sending terminal is further provided, where the file sending terminal includes a detecting module configured to detect a screen touching action of a user, a confirming module, configured to determine a to-be-transferred file according to the detected screen touching action after confirming that the screen touching action detected by the detecting module is a preset file transfer action. The terminal further has a scanning module configured to scan a file receiving terminal that establishes a connection with the terminal after confirming that the screen touching action detected by the detection module is the preset file transfer action, where the preset file transfer action has a corresponding file transfer instruction and a transferring module configured to perform a corresponding transfer operation according to the file transfer instruction.

According to still another aspect, a file transfer method is further provided, where the method includes, receiving, by a file receiving terminal, a file transfer instruction sent by a file sending terminal that establishes a connection with the file receiving terminal, and detecting a screen touching action of a user within a preset time. The method further includes returning confirmation information to the file sending terminal after detecting the screen touching action of the user and receiving a file transferred by the file sending terminal according to the confirmation information.

According to another aspect, a file receiving terminal is further provided, where the file receiving terminal includes a receiving module configured to receive a file transfer instruction sent by a file sending terminal that establishes a connection with the receiving module, a detecting module, configured to detect a screen touching action of a user within a preset time, a returning module, configured to return confirmation information to the file sending terminal after the detecting module detects the screen touching action of the user and a processing module configured to receive a file transferred by the file sending terminal.

After confirming that a detected screen touching action of a user is a preset file transfer action, a file sending terminal automatically scans a file receiving terminal that establishes a connection with the file sending terminal, and performs a corresponding transfer operation according to a file transfer instruction provided by the preset file transfer action, thereby implementing file transfer according to the detected screen touching action. Therefore, a used transfer manner does not need to be selected each time a file is transferred, implementing fast file transfer by using simple screen touching actions.

### BRIEF DESCRIPTION OF THE DRAWINGS

To describe the technical details in the embodiments more clearly, the following briefly introduces the accompanying drawings required for describing the embodiments. The accompanying drawings and the following description show embodiments at are illustrative and nonlimiting, and a person of ordinary skill in the art may still derive other drawings from these accompanying drawings without creative efforts.

FIG. 1 is a flowchart of a file transfer method according to Embodiment 1;

FIG. 2 is a flowchart of another file transfer method according to Embodiment 1;

FIG. 3 is a flowchart of a file transfer method according to Embodiment 2;

FIG. 4 is a flowchart of a file transfer method according to Embodiment 3;

FIG. 5 is a schematic structural diagram of a file sending terminal according to Embodiment 4;

FIG. 6 is a schematic structural diagram of a transferring module according to Embodiment 4;

FIG. 7 is a schematic structural diagram of a sending unit according to Embodiment 4;

FIG. 8 is a schematic structural diagram of a transferring unit according to Embodiment 4;

FIG. 9 is a schematic structural diagram of a file receiving terminal according to Embodiment 5; and

FIG. 10 is a schematic structural diagram of a file transfer system according to Embodiment 6.

### DETAILED DESCRIPTION OF ILLUSTRATIVE EMBODIMENTS

To make the objectives, technical solutions, and advantages of the embodiments clearer, the following further describes the embodiments in detail with reference to the accompanying drawings.

### Embodiment 1

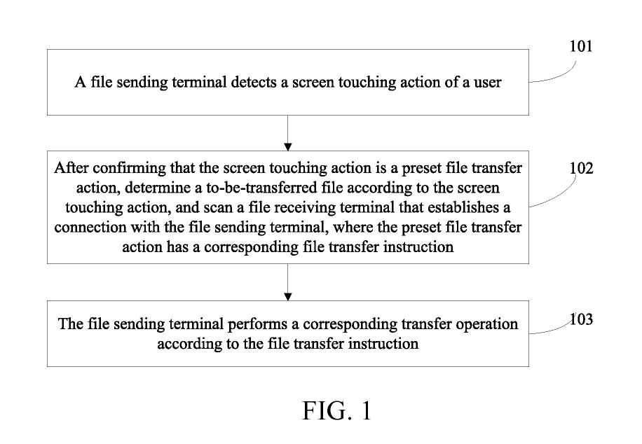

This embodiment provides a file transfer method. The method may be executed by a file sending terminal. Referring to FIG. 1, an embodiment of the method is as follows:

101: A file sending terminal detects a screen touching action of a user.

102: After confirming that the screen touching action is a preset file transfer action, determine a to-be-transferred file according to the screen touching action, and scan a file receiving terminal that establishes a connection with the file sending terminal, where the preset file transfer action has a corresponding file transfer instruction.

103: The file sending terminal performs a corresponding transfer operation according to the file transfer instruction.

The file sending terminal performs a corresponding transfer operation according to the file transfer instruction that includes:

sending the corresponding file transfer instruction to the file receiving terminal, so that the file receiving terminal that receives the file transfer instruction returns confirmation information to the file sending terminal after detecting the screen touching action of the user within a preset time; and

receiving the confirmation information returned by the file receiving terminal, and transferring the to-be-transferred file to the file receiving terminal that returns the confirmation information.

Further, if it is found from scanning that multiple file receiving terminals establish connections with the file sending terminal, the sending the file transfer instruction to the file receiving terminal includes:

sending, in a broadcast manner, the file transfer instruction to the multiple file receiving terminals found by scanning, so that the file receiving terminals that receive the file transfer instruction separately detect the screen touching action of the user, and return the confirmation information to the file sending terminal after detecting the screen touching action of the user.

The sending the corresponding file transfer instruction to the file receiving terminal includes:

determining an instruction type according to the detected screen touching action; and

sending the file transfer instruction carrying the instruction type and file information to the file receiving terminal, so that the file receiving terminal returns the confirmation information to the file sending terminal after confirming, according to the received file information, that an operation supports the instruction type,

where the file information includes at least one of a file name, a format, a type, and a size.

Further, the determining an instruction type according to the detected screen touching action includes:

if the detected screen touching action is a single-point screen touching action and the single-point screen touching action is the preset file transfer action, determining that the instruction type is file copying; or

if the to-be-transferred file is currently displayed in a full screen, the detected screen touching action is a multi-point screen touching action, and the screen touching action of at least one point is the preset file transfer action, determining that the instruction type is file displaying.

A track that corresponds to the preset file transfer action and is formed by the action is a track of sliding out of an edge of the file sending terminal, or a track of a preset shape.

Further, the instruction type includes file copying or file displaying, and the transferring the to-be-transferred file to the file receiving terminal that returns the confirmation information includes:

if the instruction type carried in the file transfer instruction is the file copying, transferring the to-be-transferred file to the file receiving terminal that returns the confirmation information, so that the file receiving terminal receives and stores the to-be-transferred file; and

if the instruction type carried in the file transfer instruction is the file displaying, transferring the to-be-transferred file and display information to the file receiving terminal that returns the confirmation information, so that the file receiving terminal displays the to-be-transferred file according to the display information.

In addition, after the transferring the to-be-transferred file and display information to the file receiving terminal that returns the confirmation information, so that the file receiving terminal displays the to-be-transferred file according to the display information, the method further includes:

adjusting the display information according to a subsequent screen touching action, and sending the adjusted display information to the file receiving terminal, so that the file receiving terminal adjusts the displayed to-be-transferred file according to the adjusted display information.

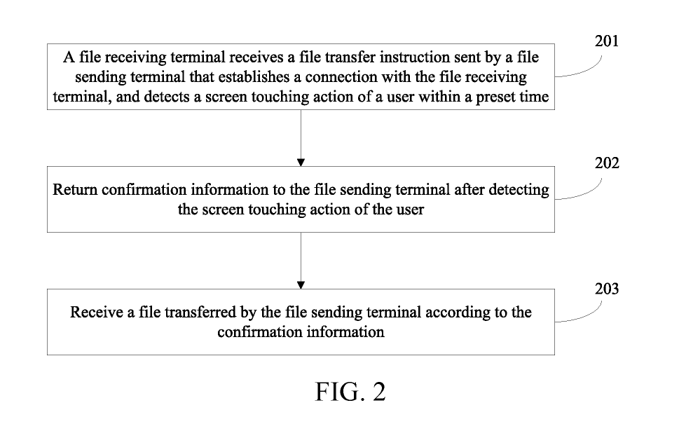

This embodiment further provides a file transfer method. The method may be executed by a file receiving terminal. Referring to FIG. 2, an embodiment of the method is as follows:

201: A file receiving terminal receives a file transfer instruction sent by a file sending terminal that establishes a connection with the file receiving terminal, and detects a screen touching action of a user within a preset time.

202: Return confirmation information to the file sending terminal after detecting the screen touching action of the user.

203: Receive a file transferred by the file sending terminal according to the confirmation information.

Further, the file transfer instruction carries an instruction type and file information.

The returning confirmation information to the file sending terminal includes:

after confirming, according to the received file information, that an operation supports the instruction type, returning the confirmation information to the file sending terminal;

where the file information includes at least one of a file name, a format, a type, and a size.

According to an embodiment method, after confirming that a detected screen touching action of a user is a preset file transfer action, a file sending terminal automatically scans a file receiving terminal that establishes a connection with the file sending terminal, and performs a corresponding transfer operation according to a file transfer instruction provided by the preset file transfer action, thereby implementing file transfer according to the detected screen touching action. Therefore, a transfer manner does not need to be selected each time a file is transferred, implementing fast file transfer by using simple screen touching actions.

To make the method provided in the foregoing embodiment clearer, the file transfer method is described in detail with reference to the content of the foregoing embodiment and by using Embodiment 2 and Embodiment 3 as an example. For details, see the following Embodiment 2 and Embodiment 3.

### Embodiment 2

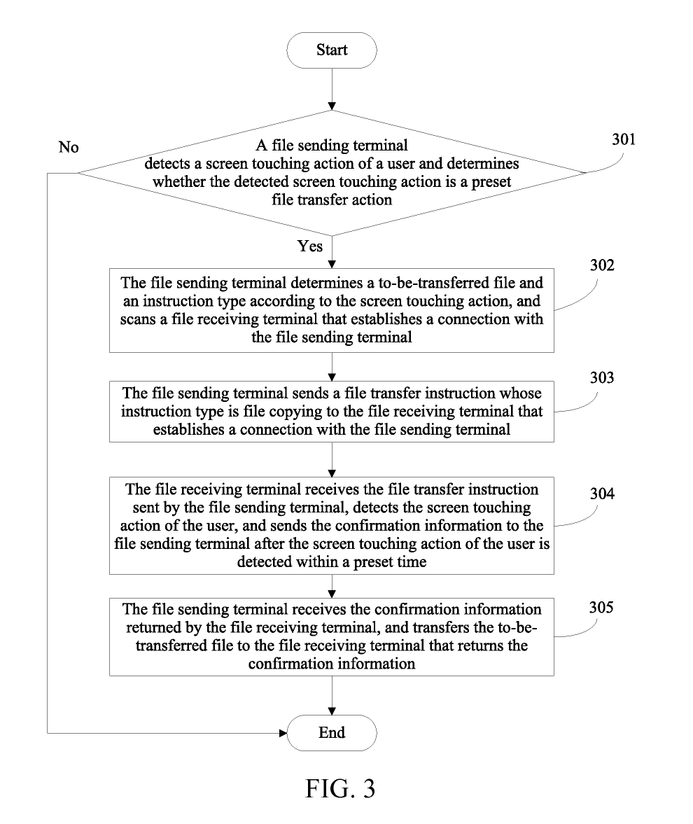

This embodiment provides a file transfer method. For ease of description, this embodiment uses a file transfer implemented by a file sending terminal and a file receiving terminal that establishes a connection with the file sending terminal as an example to describe the method provided in this embodiment in detail. Referring to FIG. 3, a process of the method is as follows:

301: The file sending terminal detects a screen touching action of a user and determines whether the detected screen touching action is a preset file transfer action; and if yes, performs step 302; if no, the process ends.

For this step, this embodiment does not limit a manner for detecting the screen touching action of the user by the file sending terminal. In an implementation, the detection can be implemented by using the conventional technology for detecting the screen touching action. The preset file transfer action may be touching and holding a selected file and quickly sliding out of a left edge or a right edge of a screen of the file sending terminal in a touching state, that is, a track corresponding to the preset screen touching action is a track of sliding out of the edge of the file sending terminal; the preset file transfer action may further be sliding a track in a preset shape on the screen of the file sending terminal, for example, sliding a track in a triangular shape or sliding a track in a tick shape, that is, the track of the preset file transfer action is the track in a preset shape. This embodiment does not limit the specific preset shape. Besides the foregoing two types of preset file transfer actions, the preset file transfer action may also be another preset file transfer action, which is not limited herein. In an implementation, for example, the preset file transfer action is touching and holding the selected file and quickly sliding out of the right edge of the screen of the file sending terminal. If a duration of the detected screen touching action of the user reaches a preset length and the track of the screen touching action is sliding out of the right edge of the screen, it is determined that the screen touching action is the preset file transfer action, and content in step 302 is performed; and if the detected screen touching action of the user is another screen touching action, the operation process of file transfer ends, the processing may be performed according to an operation of another screen touching action, and the screen touching action of the user continues to be detected.

302: The file sending terminal determines a to-be-transferred file and an instruction type according to the screen touching action and scans the file receiving terminal that establishes a connection with the file sending terminal.

For this step, after it is confirmed that the screen touching action of the user is the preset file transfer action, to implement file transfer, this step includes a process of determining the to-be-transferred file according to the screen touching action. A determining manner may be determining a file corresponding to an icon at which a start point of the screen touching action is located as the to-be-transferred file, or another manner may be adopted, which is not limited in the present disclosure. Further, because a battery icon or a drop-down menu in a main interface cannot be used for transfer, after it is detected that the screen touching action of the user is the preset file transfer action and the to-be-transferred file is determined, whether the to-be-transferred file can be used for transfer further needs to be confirmed. In an implementation, whether the selected file can be used for transfer is determined by checking an attribute of a target selected by the user. If the attribute of the target is a file format such as txt, pdf, and exe, the selected file can be used for transfer.

Besides determining the to-be-transferred file according to the screen touching action of the user, to enable the terminal that receives the to-be-transferred file to be clear about an operation on the file, the method provided in this embodiment further includes a step of determining an instruction type of a subsequently sent instruction according to the detected screen touching action. The instruction type includes but is not limited to file copying and file displaying. For example, if the detected screen touching action is a single-point screen touching action and the single-point screen touching action is the preset file transfer action, it is determined that the instruction type is the file copying; and if the to-be-transferred file is currently displayed in a full screen, the detected screen touching action is a multi-point screen touching action, and the screen touching action of at least one point is the preset file transfer action, it is determined that the instruction type is the file displaying. Besides these two types of instruction types, another instruction type may be included according to an actual requirement, which is not limited herein. This embodiment is described only by using the instruction for implementing file copying according to the single-point screen touching action as an example.

After determining the to-be-transferred file and the instruction type, the file receiving terminal that establishes the connection with the file sending terminal may be determined by scanning the connection, thereby determining to which terminal the to-be-transferred file is transferred. In an implementation, a priority sequence of scanning may be set to USB (Universal Serial Bus), NFC (Near Field Communication), WIFI (Wireless Fidelity) direct connection, and Bluetooth, or may be set to another connection manner with a high priority. It is determined according to the scanned connection manner whether the file receiving terminal that establishes a connection with the file sending terminal in the specific connection manner exists; and if the file receiving terminal does not exist, a next connection manner is scanned until the file receiving terminal that establishes a connection with the file sending terminal is found by scanning. A scanning manner belongs to the prior art, which is not further described herein.

303: The file sending terminal sends a file transfer instruction whose instruction type is file copying to the file receiving terminal that establishes the connection with the file sending terminal.

The file transfer instruction carrying the instruction type and file information is sent to the file receiving terminal over the established connection. A type of the file transfer instruction is file copying. The file information includes but is not limited to a file name, a format, a type, a size, and the like, which is not limited in this embodiment. For example, if the to-be-transferred file is an application program named XX, besides the instruction type of file copying, the file information such as the name XX, the file format.exe, and the size 122 MB is also further carried in the sent file transfer instruction.

In addition, because a one-to-many connection manner exists, for example, a Bluetooth connection, if it is found by scanning that multiple terminals establish connections with the file sending terminal in the Bluetooth connection manner, that is, it is found by scanning that multiple file receiving terminals establish connections with the file sending terminal, the file transfer instruction may be sent in a broadcast manner to the multiple file receiving terminals found by scanning. For a situation in which the file sending terminal finds by scanning that multiple file receiving terminals establish connections with the file sending terminal, after sending the file transmission instruction whose instruction type is file copying to the file receiving terminals that establish connections with the file sending terminal, the file sending terminal may directly transfer the file to all the file receiving terminals that establish connections with the file sending terminal. Therefore, a process in step 304, that is, returning confirmation information by the file receiving terminal after the screen touching action of the user is detected, can be omitted. However, for a situation in which the file sending terminal finds by scanning that multiple file receiving terminals establish connections with the file sending terminal, if the user hopes to transfer the file only to one or more of file receiving terminals thereof, instead of all the file receiving terminals, to avoid a misoperation, in the method provided in this embodiment, after performing the screen touching action on the file sending terminal, the user can further perform the screen touching action on the selected file receiving terminal; and the file receiving terminal that detects the screen touching action returns the confirmation information, so that the file sending terminal can clearly learn the file receiving terminal to which the file is transferred. Therefore, after sending the file transfer instruction whose instruction type is file copying to the file receiving terminal that establishes a connection with the file sending terminal, the file sending terminal further needs to perform the operation in the subsequent step 304. For details, see the following step.

304: The file receiving terminal receives the file transfer instruction sent by the file sending terminal, detects the screen touching action of the user, and sends confirmation information to the file sending terminal after detecting the screen touching action of the user within a preset time.

For this step, if the file receiving terminal detects the screen touching action of the user within the preset time, and a duration of keeping screen touching exceeds a preset time length, it indicates that the user hopes to transfer the file to the file receiving terminal. For example, file receiving terminals A and B simultaneously receive the file transfer instruction, but a file receiving terminal A does not detect the screen touching action of the user within the preset time, whereas a file receiving terminal B detects the screen touching action of the user, it indicates that the file receiving terminal B is the terminal that finally receives the file, that is, the user hopes to transfer the file to file receiving terminal B, and therefore slides a screen from the file sending terminal to file receiving terminal B.

Further, the preset time is a period of time after the file transfer instruction is received and may be 1 s or 0.5 s, which is not limited in this embodiment; and the time length for continuously touching the screen is a period of time after the receiving terminal detects the screen touching action of the user, which is also not limited in this embodiment and may be set to 1 s or 0.5 s in an actual application.

In addition, considering that there may be a delay in transferring an instruction but the screen touching action of the user, that is, sliding the screen from the file sending terminal to the file receiving terminal, may be very fast, it is necessary to check not only whether the screen touching action occurs within the preset time starting at a moment when the file receiving terminal receives the file transfer instruction, but also whether the screen touching action occurs within a time before the file transfer instruction is received. Because when the file transfer instruction sent by the file sending terminal is not received, if the screen touching action of the user is detected, the file transfer instruction is received when the user remains in a screen touching state, and the screen touching action does not end when receiving the file transfer instruction, a manner for copying the file required by the user can still be used for processing.

Because file types supported by the file sending terminal and the file receiving terminal may not be the same, after receiving the file transfer instruction, the file receiving terminal may acquire information such as the file type and the file size of the transferred file according to the file information carried in the file transfer instruction, and confirms whether the file receiving terminal supports the file type and whether there is sufficient memory space; and if the file receiving terminal supports the file type and there is sufficient memory space, the file receiving terminal returns the confirmation information to the file sending terminal.

305: The file sending terminal receives the confirmation information returned by the file receiving terminal, and transfers the to-be-transferred file to the file receiving terminal that returns the confirmation information.

The confirmation information returned by the file receiving terminal may carry a name or address information of the file receiving terminal, so that the file sending terminal determines the corresponding file receiving terminal after obtaining by parsing, information such as the name, n in the confirmation information, and transfers the to-be-transferred file to the file receiving terminal. For example, if the file sending terminal obtains by parsing, according to the returned confirmation information, that the name of the file receiving terminal is the file receiving terminal B, the file sending terminal sends the to-be-transferred file to file receiving terminal B over an established connection. Certainly, the confirmation information returned by the file receiving terminal may also carry other information that can identify the file receiving terminal, and this embodiment does not limit specific information carried in the confirmation information.

Because the file receiving terminal has received the file transfer instruction whose instruction type is file copying, after receiving the file sent by the file sending terminal, the file receiving terminal stores the received file, implementing file copying and storage from the file sending terminal to the file receiving terminal.

According to a method provided in this embodiment, after confirming that a detected screen touching action of a user is a preset file transfer action, a file sending terminal automatically scans a file receiving terminal that establishes a connection with the file sending terminal, and performs a corresponding transfer operation according to a file transfer instruction provided by the preset file transfer action, thereby implementing a file transfer operation according to the detected screen touching action. Therefore, a used transfer manner does not need to be selected each time a file is transferred, implementing fast file transfer by using simple screen touching actions. In addition, the file receiving terminal detects the screen touching action of the user and performs a corresponding signaling interaction with the file sending terminal, so that originally independent screen touching operations on the two terminals are combined as a function operation set, thereby improving the file transfer accuracy.

### Embodiment 3

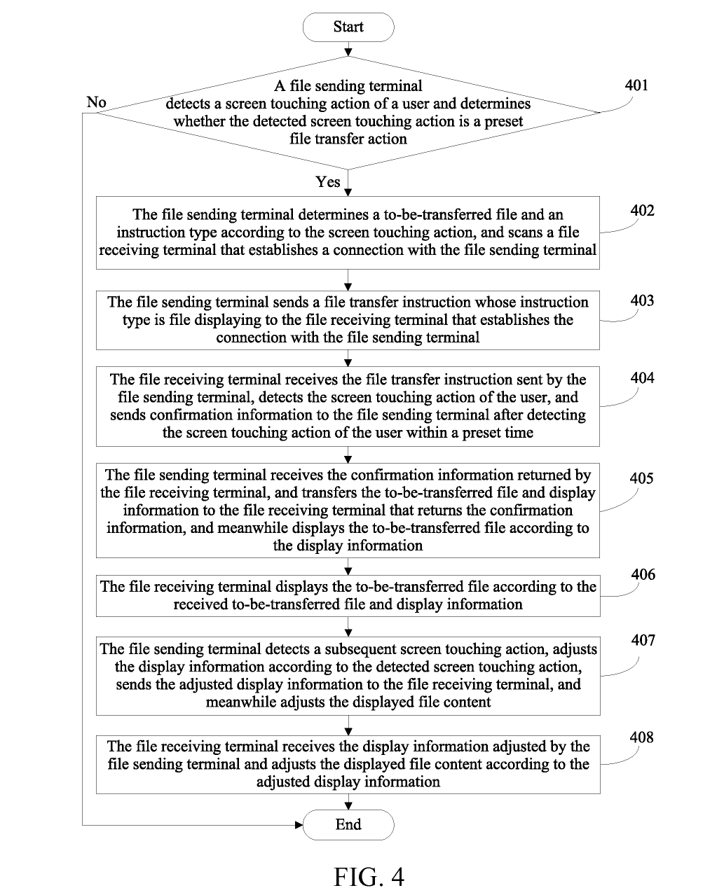

This embodiment provides a file transfer method. For ease of description, the method provided in this embodiment is described in detail by using file displaying on both a file sending terminal and a file receiving terminal that establishes a connection with the file sending terminal as an example. Referring to FIG. 4, a process of the method is as follows:

401: The file sending terminal detects a screen touching action of a user and determines whether the detected screen touching action is a preset file transfer action; and if yes, performs step 402; if no, the process ends.

For an implementation manner of this step, see the related description in step 301 in the foregoing Embodiment 2. In an implementation, if the detected screen touching action of the user is the preset file transfer action, content in step 402 is performed; otherwise, the process ends and the screen touching action of the user continues to be detected.

402: The file sending terminal determines a to-be-transferred file and an instruction type according to the screen touching action and scans the file receiving terminal that establishes a connection with the file sending terminal.

For this step, after confirming that the screen touching action of the user is the preset file transfer action, to implement file transfer, this step includes a process of determining the to-be-transferred file according to the screen touching action. A determination manner may be determining a file corresponding to an icon at which a start point of the screen touching action is located as the to-be-transferred file, or another manner may be adopted, which is not limited in the present disclosure. Further, besides determining the to-be-transferred file according to the screen touching action of the user, to enable the terminal that receives the to-be-transferred file to be clear about an operation on the file, the method provided in this embodiment further includes a step of determining an instruction type of a subsequently sent instruction according to the detected screen touching action. The instruction type includes but is not limited to file copying and file displaying. For example, if the to-be-transferred file is currently displayed in a full screen on the file sending terminal, the detected screen touching action is a multi-point screen touching action, and the screen touching action of at least one point is the preset file transfer action, it is determined that the instruction type is the file displaying. Besides these two types of instruction types, another instruction type may be included according to an actual requirement, which is not limited herein. This embodiment is described only by using the instruction for implementing file displaying according to the multi-point screen touching action as an example.

After determining the to-be-transferred file and the instruction type, the file sending terminal scans the file receiving terminal that establishes the connection with the file sending terminal to make clear to which terminal the file transfer instruction is sent. The file receiving terminal that establishes the connection with the file sending terminal may be determined by scanning a connection manner, or may be determined in another scanning manner, which is not limited herein. In an implementation, a priority sequence of scanning may be set to USB (Universal Serial Bus), NFC (Near Field Communication), WIFI (Wireless Fidelity) direct connection, and Bluetooth, or may be set to another connection manner with a high priority. It is determined according to the scanned connection manner whether the file receiving terminal that establishes a connection with the file sending terminal in the specific connection manner exists; and if the file receiving terminal does not exist, a next connection manner is scanned according to the set scanning priority sequence until the file receiving terminal that establishes a connection with the file sending terminal is found by scanning. A scanning manner belongs to the prior art, which is not further described herein.

403: The file sending terminal sends a file transfer instruction whose instruction type is file displaying to the file receiving terminal that establishes the connection with the file sending terminal.

The file transfer instruction carrying the instruction type and file information is sent to the file receiving terminal over the established connection. A type of the file transfer instruction is file displaying. The file information includes but is not limited to a file name, a format, a type, a size, and the like, which is not limited in this embodiment. For example, if the to-be-transferred file is an image file named XX, besides the instruction type of file displaying, the file information such as the name XX, the file format .jpg, and the size 122 MB is also carried in the sent file transfer instruction.

In addition, because a one-to-many connection manner exists, for example, a Bluetooth connection, if it is found by scanning that multiple terminals establish connections with the file sending terminal in the Bluetooth connection manner, that is, it is found by scanning that multiple file receiving terminals establish connections with the file sending terminal, the file transfer instruction may be sent in a broadcast manner to the multiple file receiving terminals found by scanning. For a situation in which the file sending terminal finds by scanning that multiple file receiving terminals establish connections with the file sending terminal, after sending the file transmission instruction whose the instruction type is file displaying to the file receiving terminals that establish connections with the file sending terminal, the file sending terminal may directly transfer the file to all the file receiving terminals that establish connections with the file sending terminal. Therefore, a process in step 404, that is, returning confirmation information by the file receiving terminal after the screen touching action of the user is detected, can be omitted. However, for a situation in which the file sending terminal finds by scanning that multiple file receiving terminals establish connections with the file sending terminal, if the user hopes to transfer the file to and display the file only on one or more of file receiving terminals thereof, instead of all the file receiving terminals, to avoid a misoperation, in the method provided in this embodiment, after performing the screen touching action on the file sending terminal, the user can further perform the screen touching action on the selected file receiving terminal; and the file receiving terminal that detects the screen touching action returns the confirmation information, so that the file sending terminal can clearly learn the file receiving terminal to which the file is transferred. Therefore, after sending the file transfer instruction where the instruction type is file displaying to the file receiving terminal that establishes a connection with the file sending terminal, the file sending terminal further needs to perform the operation in the subsequent step 404. For details, see the following step.

404: The file receiving terminal receives the file transfer instruction sent by the file sending terminal, detects the screen touching action of the user, and sends confirmation information to the file sending terminal after detecting the screen touching action of the user within a preset time.

For this step, if the file receiving terminal detects the screen touching action of the user within the preset time, and a duration of keeping screen touching exceeds a preset time length, it indicates that the user hopes to transfer the file to the file receiving terminal. For example, file receiving terminals A and B simultaneously receive the file transfer instruction, but a file receiving terminal A does not detect the screen touching action of the user within the preset time, whereas a file receiving terminal B detects the screen touching action of the user, it indicates that the file receiving terminal B is the terminal that finally receives the file, that is, the user hopes to transfer the file to file receiving terminal B, and therefore slides a screen from the file sending terminal to file receiving terminal B.

Further, the preset time is a period of time after the file transfer instruction is received and may be 1 s or 0.5 s, which is not limited in this embodiment; and the time length for continuously touching the screen is a period of time after the receiving terminal detects the screen touching action of the user, which is also not limited in this embodiment and may be set to 1 s or 0.5 s in an actual application.

In addition, considering that there may be a delay in transferring an instruction but the screen touching action of the user, that is, sliding the screen from the file sending terminal to the file receiving terminal, may be very fast, it is necessary to check not only whether the screen touching action occurs within the preset time starting at a moment when the file receiving terminal receives the file transfer instruction, but also whether the screen touching action occurs within a time before the file transfer instruction is received. Because when the file transfer instruction sent by the file sending terminal is not received, if the screen touching action of the user is detected, the file transfer instruction is received when the user remains in a screen touching state, and the screen touching action does not end when receiving the file transfer instruction, a manner for transferring the file required by the user can still be used for processing.

Because file types supported by the file sending terminal and the file receiving terminal may not be the same, after receiving the file transfer instruction, the file receiving terminal may acquire information such as the file type and the file size of the transferred file according to the file information carried in the file transfer instruction, and judges whether the file receiving terminal supports the file type and whether there is sufficient memory space; and if the file receiving terminal supports the file type and there is sufficient memory space, the file receiving terminal returns the confirmation information to the file sending terminal.

405: The file sending terminal receives the confirmation information returned by the file receiving terminal, and transfers the to-be-transferred file and display information to the file receiving terminal that returns the confirmation information, and meanwhile displays the to-be-transferred file according to the display information.

The confirmation information returned by the file receiving terminal may carry a name or address information of the file receiving terminal, so that the file sending terminal determines the corresponding file receiving terminal after obtaining by parsing, information such as the name, from the confirmation information, and transfers the to-be-transferred file to the file receiving terminal. For example, if the file sending terminal obtains by parsing, according to the returned confirmation information, that the name of the file receiving terminal is the file receiving terminal B, the file sending terminal sends the to-be-transferred file to file receiving terminal B over an established connection. Certainly, the confirmation information returned by the file receiving terminal may also carry other information that can identify the file receiving terminal, and this embodiment does not limit specific information carried in the confirmation information.

After the confirmation information returned by the file receiving terminal is received, to control an image form displayed by the file receiving terminal, the method provided by this embodiment further includes a step of sending the display information when the file sending terminal sends the to-be-transferred file to the file receiving terminal. The display information includes but is not limited to information such as a size of the displayed file for controlling a range of the to-be-transferred file displayed by the file receiving terminal. In an actual application process, the file sending terminal may set the display information according to the screen touching action of the user. For example, if the detected screen touching action of the user is a multi-point screen touching, tracks of two points are gradually apart, and another point is slid out from the left edge of the file sending terminal while the screen touching action of enlarging the displayed file is performed, it can be determined that the image currently displayed in a full screen needs to be enlarged for displaying, and the right half part is displayed on the file sending terminal and the left half part is displayed on the file receiving terminal; and for this type of screen touching action, the display range in the display information may be pixels of the left half part of the to-be-transferred file, that is, controlling the file receiving terminal to display the left half part of the to-be-transferred file. If the detected screen touching action of the user is sliding out from the right edge of the file sending terminal, it can be determined that the image currently displayed in a full screen needs to be enlarged for displaying, and the left half part is displayed on the file sending terminal and the right left part is displayed on the file receiving end; and for this type of screen touching action, the display information is pixels of the right half part of the to-be-transferred file, that is, controlling the file receiving terminal to display the right half part of the to-be-transferred file.

Besides using the foregoing manner of determining the display information to send the corresponding display information to the file receiving terminal, another manner of determining the display information may be selected, and other display information may also be obtained, which is not limited in this embodiment. Because the size of the to-be-transferred file is known to the file sending terminal, after determining, according to the screen touching action, which part of the to-be-transferred is to be displayed, the file sending terminal can determine a pixel range of the to-be-transferred file displayed at the local end and the file receiving terminal; in addition, irrespective of what type of display information is sent by the file sending terminal to the file receiving terminal, the file sending terminal needs to display the to-be-transferred file according to the display information after sending the to-be-transferred file to the file receiving terminal. For example, if the display information sent by the file sending terminal to the file receiving terminal is the pixels of the right half part of the to-be-transferred file, the file sending terminal displays the left half part of the to-be-transferred file; and if the display information sent by the file sending terminal to the file receiving terminal is the pixels of the left half part of the to-be-transferred file, the file sending terminal displays the right half part of the to-be-transferred file.

406: The file receiving terminal displays the to-be-transferred file according to the received to-be-transferred file and display information.

Because the file receiving terminal previously receives the file transfer instruction whose instruction type is image displaying, after receiving the to-be-transferred file and the display information sent by the file sending terminal, the file receiving terminal can display the to-be-transferred file according to the display information, and content displayed by the file sending terminal combined with the content displayed by the file receiving terminal are the entire to-be-transferred file.

It should be noted that, to display one file on two terminals, especially to display one image file, when the method provided by this embodiment is implemented, two terminals of the same specifications can be adopted, that is, the specifications of the file sending terminal and file receiving terminal are the same, for example, models of two terminals are the same or screen pixels are the same, so as to ensure that two parts of one image that are separately displayed on the two terminals can be spliced into a complete image.

In addition, according to the method provided by this embodiment, because both the file sending terminal and the file receiving terminal need to detect the screen touching action of the user, a situation in which two terminals display the same file is ended accordingly once the screen touching action disappears. For a situation in which the screen touching action does not disappear, after the file sending terminal and the file receiving terminal separately display a part of the to-be-transferred file, the screen touching action may also subsequently continue to occur on the two terminals. For a processing manner after the subsequent screen touching action occurs, see the following steps.

407: The file sending terminal detects a subsequent screen touching action, adjusts the display information according to the detected screen touching action, sends the adjusted display information to the file receiving terminal, and meanwhile adjusts the displayed file content.

The file sending terminal detects the screen touching action of the user and adjusts the display information according to the detected screen touching action; in an actual application, the corresponding display information may be adjusted in real time according to a distance between two points of screen touching on two terminals, and the displayed file is enlarged or shrunk. For example, it may be set as follows: the file is enlarged for displaying when the distance is increased, or the file is shrunk for displaying when the distance is shorter. Regardless of enlarging or shrinking, the file sending terminal can determine the adjusted display information according to a display situation of the file and send the adjusted display information to the file receiving terminal, so that the two terminals simultaneously adjust the displayed file content.

408: The file receiving terminal receives the display information adjusted by the file sending terminal, and adjusts the displayed file content according to the adjusted display information.

For this step, the file receiving terminal performs corresponding processing on the displayed file according to the received adjusted display information, that is, displays the file according to the pixels in the adjusted display information.

According to a method provided in this embodiment, after confirming that a detected screen touching action of a user is a preset file transfer action, a file sending terminal automatically scans a file receiving terminal that establishes a connection with the file sending terminal, and performs a corresponding transfer operation according to a file transfer instruction provided by the preset file transfer action, thereby implementing a file transfer and display operation according to the detected screen touching action. Therefore, a used transfer manner does not need to be selected each time a file is transferred, implementing fast file transfer and split-screen displaying of the file by using simple screen touching actions. In addition, the file receiving terminal detects the screen touching action of the user and performs a corresponding signaling interaction with the file sending terminal, so that originally independent screen touching operations on the two terminals are combined as a function operation set, thereby improving the file transfer accuracy.

### Embodiment 4

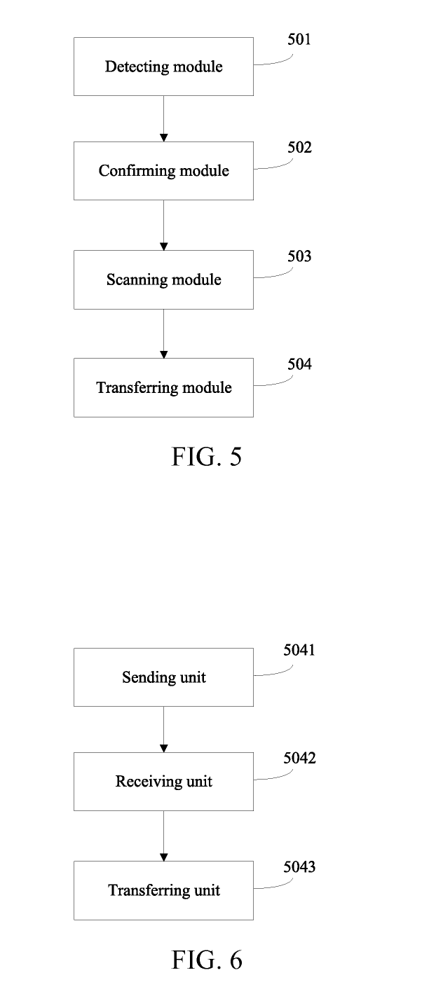

This embodiment provides a file sending terminal. The file sending terminal is configured to perform steps for sending a file in the foregoing Embodiment 1, Embodiment 2, and Embodiment 3. Referring to FIG. 5, the file sending terminal includes:

a detecting module 501, configured to detect a screen touching action of a user;

a confirming module 502, configured to determine a to-be-transferred file according to the detected screen touching action after confirming that the screen touching action detected by the detecting module 501 is a preset file transfer action;

a scanning module 503, configured to: after confirming that the screen touching action detected by the detection module 501 is the preset file transfer action, scan a file receiving terminal that establishes a connection with the terminal, where the preset file transfer action has a corresponding file transfer instruction; and

a transferring module 504, configured to perform a corresponding transfer operation according to the file transfer instruction.

Referring to FIG. 6, the transferring module 504 includes:

a sending unit 5041, configured to send the corresponding file transfer instruction to the file receiving terminal scanned by the scanning module 503, so that the file receiving terminal that receives the file transfer instruction returns confirmation information after detecting the screen touching action of the user within a preset time;

a receiving unit 5042, configured to receive the confirmation information returned by the file receiving terminal; and

a transferring unit 5043, configured to transfer the to-be-transferred file determined by the confirming module 502 to the file receiving terminal that returns the confirmation information.

The sending unit 5041 is further configured to: if the scanning module 503 finds by scanning that multiple file receiving terminals establish connections with a local end, send, in a broadcast manner, the file transfer instruction to the multiple file receiving terminals found by scanning, so that the file receiving terminals that receive the file transfer instruction separately detect the screen touching action of the user and return the confirmation information after detecting the screen touching action of the user.

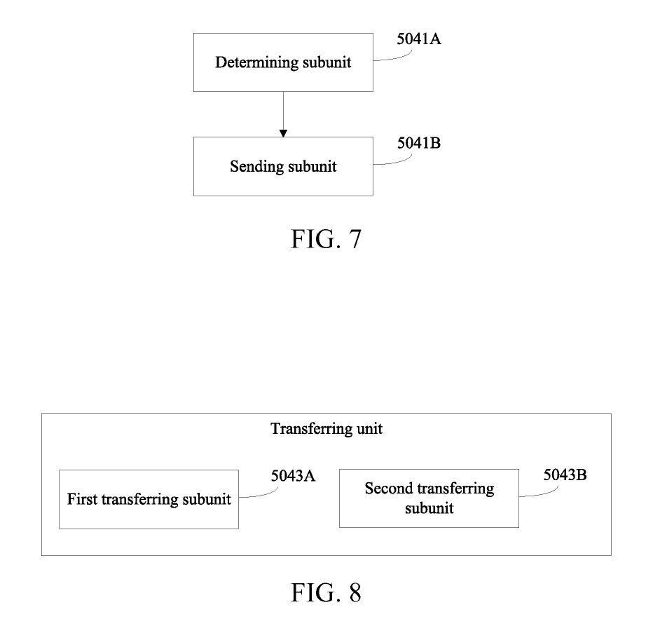

Referring to FIG. 7, the sending unit 5041 includes:

a determining subunit 5041A, configured to determine an instruction type according to the detected screen touching action; and

a sending subunit 5041B, configured to send the file transfer instruction carrying the instruction type determined by the determining subunit 5041A and file information to the file receiving terminal, so that the file receiving terminal returns the confirmation information to the file sending terminal after confirming, according to the received file information, that an operation supports the instruction type;

where the file information includes at least one of a file name, a format, a type, and a size.

The determining subunit 5041A is configured to: if the detected screen touching action is a single-point screen touching action and the single-point screen touching action is the preset file transfer action, determine that the instruction type is file copying; and if the to-be-transferred file is currently displayed in a full screen, the detected screen touching action is a multi-point screen touching action, and the screen touching action of at least one point is a preset file transfer action, determine that the instruction type is file displaying.

Further, the instruction type includes file copying and file displaying. Referring to FIG. 8, the transferring unit 5043 includes:

a first transferring subunit 5043A, configured to: if the instruction type carried in the file transfer instruction is the file copying, transfer the to-be-transferred file to the file receiving terminal that returns the confirmation information, so that the file receiving terminal receives and stores the to-be-transferred file; and

a second transferring subunit 5043B, configured to: if the instruction type carried in the file transfer instruction is the file displaying, transfer the to-be-transferred file and display information to the file receiving terminal that returns the confirmation information, so that the file receiving terminal displays the to-be-transferred file according to the display information.

In addition, the second transferring subunit 5043B is further configured to adjust the display information according to a subsequent screen touching action, and send the adjusted display information to the file receiving terminal, so that the file receiving terminal adjusts the displayed to-be-transferred file according to the adjusted display information.

A file sending terminal provided in this embodiment, after confirming that a detected screen touching action of a user is a preset file transfer action, automatically scans a file receiving terminal that establishes a connection with the file sending terminal, and performs a corresponding transfer operation according to a file transfer instruction provided by the preset file transfer action, thereby implementing file transfer according to the detected screen touching action. Therefore, a used transfer manner does not need to be selected each time a file is transferred, implementing fast file transfer by using simple screen touching actions.

### Embodiment 5

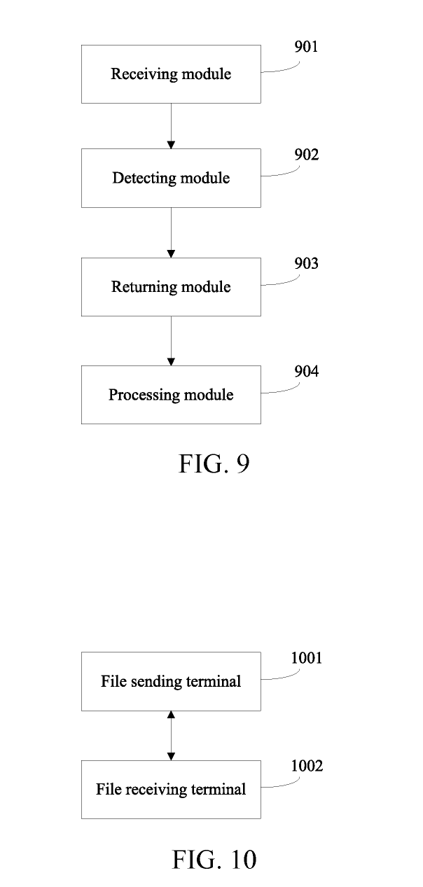

This embodiment provides a file receiving terminal. The file receiving terminal is configured to perform steps for receiving a file in the foregoing Embodiment 1, Embodiment 2, and Embodiment 3. Referring to FIG. 9, the file receiving terminal includes:

a receiving module 901, configured to receive a file transfer instruction sent by a file sending terminal that establishes a connection with the receiving module;

a detecting module 902, configured to detect a screen touching action of a user within a preset time;

a returning module 903, configured to return confirmation information to the file sending terminal after the detecting module 902 detects the screen touching action of the user; and

a processing module 904, configured to receive a file transferred by the file sending terminal.

The file transfer instruction received by the receiving module 901 carries an instruction type and file information.

The returning module 903 is configured to return the confirmation information to the file sending terminal after confirming, according to the file information received by the receiving module 901, that an operation supports the instruction type.

The file information includes at least one of a file name, a format, a type, and a size.

A file receiving terminal provided by this embodiment, after receiving an instruction sent by a file sending terminal, detects a screen touching action of a user and returns a confirmation to the file sending terminal according to the detected screen touching action, so that an operation of transferring the file from the file sending terminal to file receiving terminal is performed. This not only implements fast file transfer by using simple screen touching actions, but also improves the file transfer accuracy.

### Embodiment 6

This embodiment provides a file transfer system. Referring to FIG. 10, the system includes a file sending terminal 1001 and a file receiving terminal 1002.

The file sending terminal 1001 is the file sending terminal provided in the foregoing Embodiment 4, and the file receiving terminal 1002 is the file receiving terminal provided in the foregoing Embodiment 5.

In a system provided in this embodiment, after confirming that a detected screen touching action of a user is a preset file transfer action, a file sending terminal automatically scans a file receiving terminal that establishes a connection with the file sending terminal, and performs a corresponding transfer operation according to a file transfer instruction provided by the preset file transfer action, thereby implementing a file transfer operation according to the detected screen touching action. Therefore, a used transfer manner does not need to be selected each time a file is transferred, implementing fast file transfer by using simple screen touching actions. In addition, the file receiving terminal detects the screen touching action of the user and performs a corresponding signaling interaction with the file sending terminal, so that originally independent screen touching operations on the two terminals are combined as a function operation set, thereby improving the file transfer accuracy.

It should be noted that when the file sending terminal and file receiving terminal provided in the foregoing embodiment perform data transfer, the division of the foregoing functional modules is used as an example for description. In the actual applications, the foregoing functions may be implemented by different functional modules according to an actual requirement, that is, different functional modules are divided according to the internal structure of the terminal to complete the foregoing all or some functions. In addition, the file transfer system, file sending terminal, file receiving terminal, and file transfer method provided in the foregoing embodiment are based on the same conception. For the detailed implementation process, see the method embodiment, which is not further described herein.

A person of ordinary skill in the art may understand that all or a part of the steps of the embodiments may be implemented by hardware or a program instructing relevant hardware. The program may be stored in a computer readable storage medium. The storage medium may include: a read-only memory, a magnetic disc, an optical disc, or the like.

The foregoing descriptions are merely exemplary embodiments, but are not intended to limit the present disclosure. Any modification, equivalent replacement, and improvement made without departing from the spirit and principle of the embodiments shall fall within the protection scope of the claims.

What is claimed is:

1. A file transfer method comprising:
detecting, by a file sending terminal, a screen touching action at the file sending terminal by a first user;
determining that the screen touching action is a preset file transfer action, wherein the preset file transfer action has a corresponding file transfer instruction;
determining a to-be-transferred file according to the screen touching action;
determining a file receiving terminal with which a connection with the file sending terminal can be established; and
performing, by the file sending terminal, a transfer operation according to the corresponding file transfer instruction.

2. The method according to claim 1, wherein the performing, by the file sending terminal, a transfer operation according to the corresponding file transfer instruction comprises:
sending the corresponding file transfer instruction to the file receiving terminal;
receiving, from the file receiving terminal, confirmation information returned within a preset time of the file sending terminal detecting the screen touching action of the first user, the confirmation information returned in response to an operation at the file receiving terminal by a second user; and
transferring the to-be-transferred file to the file receiving terminal that returns the confirmation information.

3. The method according to claim 2, wherein the sending the corresponding file transfer instruction to the file receiving terminal comprises:
determining an instruction type according to the detected screen touching action; and
sending the file transfer instruction carrying the instruction type and file information of the to-be-transferred file to the file receiving terminal;
wherein the confirmation information confirms support by the file receiving terminal of a transfer operation corresponding to the instruction type and according to the received file information; and
wherein the file information comprises at least one of a file name, a format, a type, and a size.

4. The method according to claim 3, wherein the determining an instruction type according to the detected screen touching action comprises:
determining that the instruction type is file copying in response to the detected screen touching action being a single-point screen touching action and the single-point screen touching action being the preset file transfer action; and
determining that the instruction type is file displaying in response to the to-be-transferred file being displayed in a full screen, the detected screen touching action being a multi-point screen touching action, and the screen touching action of at least one point being the preset file transfer action.

5. The method according to claim 4, wherein the preset file transfer action comprises one of sliding a track from an edge of the file sending terminal by the first user, and sliding a track in a preset shape by the first user.

6. The method according to claim 3, wherein the instruction type comprises one of file copying and file displaying; and
wherein the transferring the to-be-transferred file to the file receiving terminal that returns the confirmation information comprises:
transferring, in response to the instruction type carried in the file transfer instruction being the file copying, the to-be-transferred file to the file receiving terminal for reception and storage of the to-be-transferred file by the file receiving terminal; and
transferring, in response to the instruction type carried in the file transfer instruction being the file displaying, the to-be-transferred file and display information to the file receiving terminal for display of to-be-transferred file by the file receiving terminal and the according to the display information.

7. The method according to claim 6, further comprising:
adjusting the display information according to a subsequent screen touching action after the transferring the to-be-transferred file and display information to the file receiving terminal; and
sending the adjusted display information to the file receiving terminal for displaying, on the file receiving terminal, the to-be-transferred file according to the adjusted display information.

8. A file sending terminal comprising:
a touch sensitive screen, configured to detect a screen touching action of a first user, wherein the first user is corresponding to the file sending terminal;
a memory; and
a processor coupled with the memory and the touch sensitive screen, wherein the processor is configured to:
determine that the screen touching action is a preset file transfer action, wherein the preset file transfer action has a corresponding file transfer instruction;
determine a to-be-transferred file according to the screen touching action;
determine a file receiving terminal with which a connection with the file sending terminal can be established; and
perform a corresponding transfer operation according to the file transfer instruction.

9. The file sending terminal according to claim 8, wherein the processor is further configured to:
send the corresponding file transfer instruction to the file receiving terminal;
receive a confirmation information that is returned by the file receiving terminal in response to an operation of a second user on the file receiving terminal, wherein the confirmation information is returned by the file receiving terminal within a preset time after the file sending terminal detecting the screen touching action of the first user; and
transfer the to-be-transferred file to the file receiving terminal.

10. The file sending terminal according to claim 9, wherein the processor is further configured to:
determine an instruction type according to the detected screen touching action; and
send the file transfer instruction carrying the instruction type and file information of the to-be-transferred file to the file receiving terminal;
wherein the confirmation information confirms support of the transfer operation by the file receiving terminal and corresponding to the instruction type according to the received file information; and
wherein the file information comprises at least one of a file name, a format, a type, and a size.

11. The file sending terminal according to claim 10, wherein the processor is further configured to:
determine that the instruction type is file copying in response to the detected screen touching action being a single-point screen touching action and the single-point screen touching action being the preset file transfer action; and
determine that the instruction type is file displaying in response to the to-be-transferred file being currently displayed in a full screen, the detected screen touching action being a multi-point screen touching action, and the screen touching action of at least one point being the preset file transfer action.

12. The file sending terminal according to claim 11, wherein the preset file transfer action comprises one of sliding a track from an edge of the file sending terminal by the first user, sliding a track in a preset shape by the first user.

13. The file sending terminal according to claim 10, wherein the instruction type comprises one of file copying and file displaying; and
wherein the processor is further configured to:
transfer, in response to the instruction type carried in the file transfer instruction being the file copying, the to-be-transferred file to the file receiving terminal so that the file receiving terminal receives and stores the to-be-transferred file; and
transfer, in response to the instruction type carried in the file transfer instruction being the file displaying, the to-be-transferred file and display information to the file receiving terminal, so that the file receiving terminal displays the to-be-transferred file according to the display information.

14. The file sending terminal according to claim 13, wherein the instruction type comprises one of file copying and file displaying; and
wherein the processor is further configured to:
adjust the display information according to a subsequent screen touching action; and
send the adjusted display information to the file receiving terminal so that the file receiving terminal adjusts the displayed to-be-transferred file according to the adjusted display information.
